(19) United States
(12) Patent Application Publication
(10) Pub. No.: US 2013/0287577 A1
(43) Pub. Date: Oct. 31, 2013

(54) ROTOR-ARM ASSEMBLY AND A MULTI-ROTORCRAFT

(71) Applicant: Singapore Technologies Aerospace Ltd., Singapore (SG)

(72) Inventors: Zhikang LIN, Singapore (SG); Wenrong LIM, Singapore (SG); Randy Yau Kee LEONG, Singapore (SG)

(21) Appl. No.: 13/849,800

(22) Filed: Mar. 25, 2013

(30) Foreign Application Priority Data
Apr. 11, 2012 (SG) 201202621-7

(51) Int. Cl. B64C 11/04

(52) U.S. Cl. CPC B64C 11/04
USPC 416/210 R

(57) ABSTRACT

Various embodiments provide a rotor-arm assembly for a multi-rotorcraft, the rotor-arm assembly comprising: a plurality of rotor-arms, each rotor-arm comprising a rotor assembly at a distal end portion and a body portion connector at a proximal end portion, the body portion connector having a screw thread; and a body portion comprising a plurality of rotor-arm connectors, each rotor-arm connector having a screw thread; wherein the screw-thread of each body portion connector is configured in use to engage with the screw-thread of one of the rotor-arm connectors to detachably attach each rotor-arm to the body portion.

### FIELD OF INVENTION

Various embodiments relate to a rotor-arm assembly and a multi-rotorcraft.

### BACKGROUND

Multi-rotorcraft unmanned aerial vehicles (UAV), such as, for example, quadrotors, tricopters, hexacopters and the like, can have a relatively large diameter footprint. This size can affect the packability of the rotorcraft. Therefore, some rotorcrafts include detachable rotor-arms. Accordingly, rotor-arms can be detached from a body portion to reduce the footprint for packing. Furthermore, detachable rotor-arms can be advantageous from a maintainability perspective. For example, if one of the rotor-arms malfunctions, a replacement rotor-arm may be installed. Accordingly, the entire rotorcraft need not be grounded until the faulty rotor-arm is repaired.

### SUMMARY

Various embodiments provide a rotor-arm assembly for a multi-rotorcraft, the rotor-arm assembly comprising: a plurality of rotor-arms, each rotor-arm comprising a rotor assembly at a distal end portion and a body portion connector at a proximal end portion, the body portion connector having a screw thread; and a body portion comprising a plurality of rotor-arm connectors, each rotor-arm connector having a screw thread; wherein the screw-thread of each body portion connector is configured in use to engage with the screw-thread of one of the rotor-arm connectors to detachably attach each rotor-arm to the body portion.

In an embodiment, a rotor-arm further comprises a tubular rod.

In an embodiment, the body portion connector of the rotor-arm comprises a plug portion, the plug portion being adapted to fit inside a proximal end portion of the tubular rod to fix the body portion connector to the tubular rod.

In an embodiment, the plug portion is configured in use to extend about 20 mm inside the tubular rod from the proximal end portion.

In an embodiment, the rotor-arm further comprises an alignment mechanism configured in use to align the body portion connector with respect to the tubular rod when the tubular rod and the body portion connector are fixed together.

In an embodiment, the alignment mechanism comprises a protrusion and a cooperating slot.

In an embodiment, the alignment mechanism further comprises a locking mechanism configured in use to lock together the tubular rod and the body portion connector.

In an embodiment, the tubular rod comprises the slot and the body portion connector comprises the protrusion, at least part of the protrusion being configured in use to extend radially beyond an outer surface of the tubular rod when the tubular rod and the body portion connector are fixed together, wherein the locking mechanism comprises a band configured in use to tighten around a circumference of the tubular rod at a proximal side of the at least part of the protrusion.

In an embodiment, the rotor assembly comprises a housing configured in use to receive at least part of a motor, the housing having a bracket for connecting to a distal end portion of the tubular rod.

In an embodiment, the housing comprises an aperture in a top portion, the aperture being configured in use to receive a motor axle therethough.

In an embodiment, the housing comprises at least one aperture for providing ventilation to the motor.

In an embodiment, the bracket extends substantially along a full length of a sidewall of the housing.

In an embodiment, the bracket comprises a groove configured in use to receive the distal end portion of the tubular rod.

In an embodiment, the rotor assembly further comprises a fastening configured in use to fix the distal end portion of the tubular rod to the groove.

In an embodiment, an orientation of the fastening is perpendicular to an orientation of the alignment mechanism.

In an embodiment, the housing is configured in use to mount a majority of the motor below a top surface of the tubular rod when the rotor-arm is attached to the body portion.

In an embodiment, one of the rotor-arm connectors of the body portion comprises a flange and the body portion comprises an aperture for receiving a portion of the rotor-arm connector therethrough, wherein the flange is configured in use to abut a sidewall of the body portion to hold the rotor-arm connector in position.

In an embodiment, the rotor-arm assembly further comprises a fastening configured in use to fix the flange to the sidewall of the body portion.

In an embodiment, the rotor-arm further comprises a reinforcement rib connected to an interior portion of the sidewall of the body portion.

In an embodiment, the reinforcement rib is formed integrally with the sidewall of the body portion.

In an embodiment, the reinforcement rib is configured in use to abut a floor of the body portion.

In an embodiment, the reinforcement rib is perpendicular to the sidewall of the body portion and the floor of the body portion.

In an embodiment, the reinforcement rib has a substantially triangular shape.

In an embodiment, the rotor-arm assembly further comprises a detachable top-cover, the detachable top-cover being connectable to the body portion via a fastening.

Various embodiments provide a multi-rotorcraft comprising a rotor-arm assembly according to any one of the above-described embodiments.

### BRIEF DESCRIPTION OF THE DRAWINGS

Embodiments of the invention will be better understood and readily apparent to one of ordinary skill in the art from the following written description, by way of example only, and in conjunction with the drawings, wherein like reference signs relate to like components, in which:

FIG. 1 is a perspective view of a multi-rotorcraft according to an embodiment;

FIG. 2A is a top view of a rotor-arm according to an embodiment; whereas FIG. 2B is corresponding side view;

FIG. 3 is a side view of a rotor-arm according to an embodiment;

FIG. 4 is a side view of a body portion connector according to an embodiment;

FIG. 5 is a perspective view of a body portion according to an embodiment;

FIG. 6A is a front view of a body portion connector according to an embodiment; whereas FIG. 6B is a corresponding side view;

FIG. 7A is a top view of a body portion including a top-cover; whereas FIG. 7B is a corresponding perspective view; FIG. 7C is a magnified view of a portion of FIG. 7A, and FIG. 7D is a cross-section view of part of FIG. 7C;

FIGS. 8 and 9 are perspective views of a rotor-arm assembly according to an embodiment; and,

FIG. 10A is a perspective view of a bag for carrying an embodiment, the bag being in a closed configuration; whereas FIG. 10B is a perspective view of the bag in an open configuration.

### DETAILED DESCRIPTION OF THE PREFERRED EMBODIMENTS

Various embodiments relate to a rotor-arm assembly for a muti-rotorcraft and a multi-rotorcraft comprising the rotor-arm assembly.

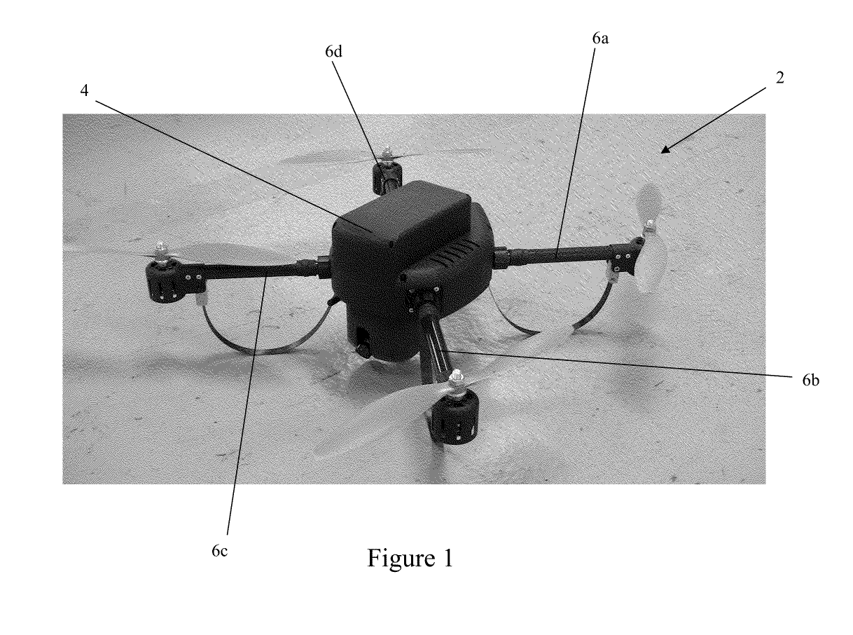

FIG. 1 illustrates a multi-rotorcraft 2 according to an embodiment. The multi-rotorcraft 2 includes a body portion 4 and four rotor-arms 6a, 6b, 6c and 6d. In an embodiment, each rotor-arm 6 is detachably attached to the body portion 4. In an embodiment, each rotor-arm 6 may be screwed onto the body portion 4. Each rotor-arm 6 may further include a rotor assembly which is configured in use to provide a lift force so that the multi-rotor craft can fly.

It is to be understood that in the foregoing description the term ‘body portion’ is intended to include both the complete body of the multi-rotorcraft and only a part of the complete body.

It is also to be understood that in the foregoing description relative terms such as ‘top’, ‘bottom’, ‘side’, ‘front’, ‘back’, etc., refer to the various features when orientated to form a multi-rotorcraft as shown in FIG. 1. For example, in this configuration, the rotor blades are on top.

An embodiment of the rotor-arm 6 will now be described in detail.

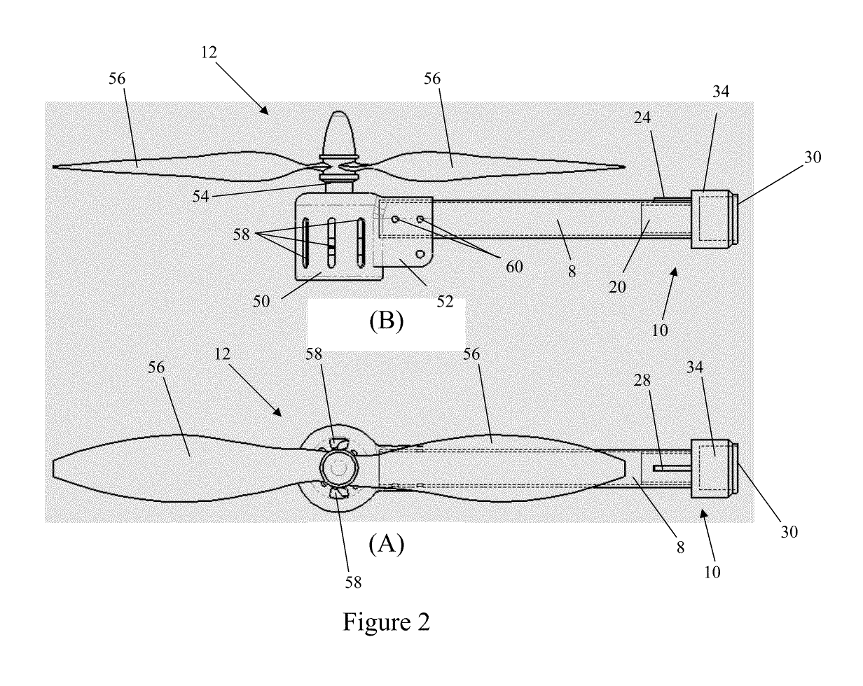

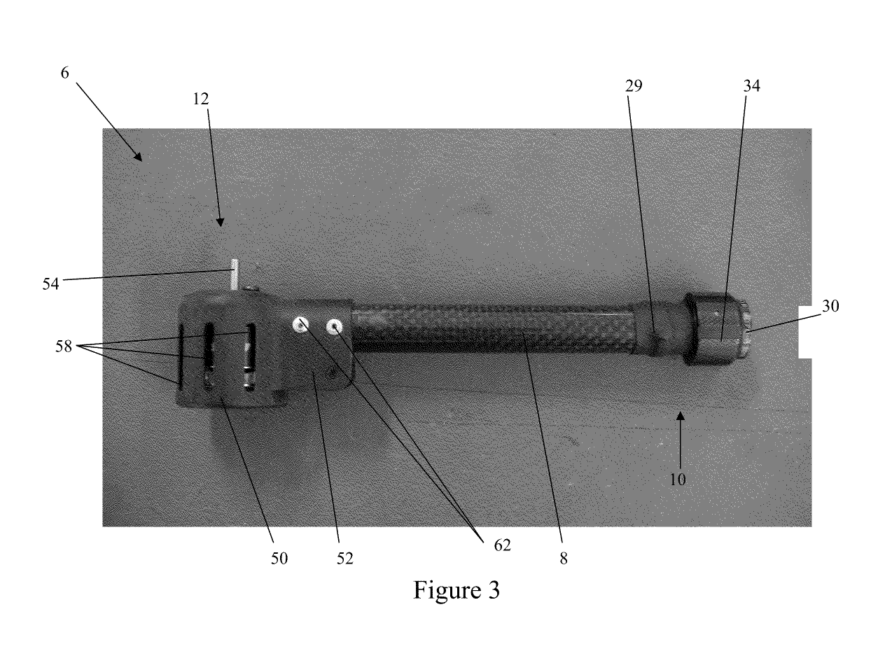

FIGS. 2A, 2B and 3 illustrate in more detail an exemplary rotor-arm 6. As seen more particularly in FIGS. 2A and 2B, the rotor-arm may include a tubular rod 8 connected at a proximal end portion to a body portion connector 10. Also, the tubular rod 8 may be connected at a distal end portion to a rotor assembly 12.

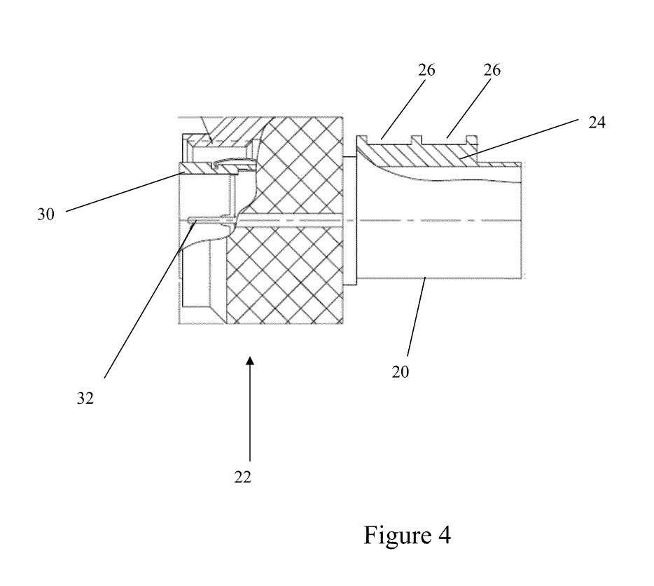

FIG. 4 illustrates in more detail the body portion connector 10 in accordance with an embodiment. The body portion connector 10 may include a plug portion 20 and a connector portion 22. In an embodiment, the plug portion 20 is adapted to fit inside a proximal end portion of the tubular rod 8. In particular, the plug portion 20 may be specifically sized and shaped to fit snugly inside a bore of the tubular rod 8. In an embodiment, the tubular rod 8 and the plug portion 20 may have circular cross-sections and the diameter of the plug portion 20 cross-section may be between about 0.1 mm and about 1.0 mm, and preferably about 0.5 mm less than the diameter of the bore of the tubular rod 8. Accordingly, a snug fit is ensured. In an embodiment, the plug portion is adapted to extend between about 15 mm and about 25 mm, and preferably about 20 mm inside the tubular rod from its proximal end.

In an embodiment, the plug portion 20 further includes a protrusion 24. The protrusion 24 may include one or more grooves 26 along its length. Accordingly, the protrusion 24 may have a turreted profile. The protrusion 24 may form part of an alignment mechanism. Specifically, as seen more particularly on FIG. 2A, the tubular rod 8 may include a slot 28 positioned at its proximal end portion. The slot 28 may form part of the alignment mechanism. In an embodiment, the slot 28 is located on top of the tubular rod when the rotor-arm 6 is attached to the body portion 4. Advantageously, this configuration may simplify manufacturing.

In operation, the body portion connector 10 may be fixed to the tubular rod 8 by sliding the plug portion 20 inside the bore of the tubular rod 8. In order that the body portion connector 10 may be inserted inside the tubular rod 8, the protrusion 24 may be aligned with the slot 28. In other words, the protrusion 24 may slide into the slot 28. Accordingly, the alignment mechanism may be used to ensure alignment between the tubular rod 8 and the body portion connector 10. Stated differently, the tubular rod 8 and the body portion connector 10 may be aligned via a protrusion and a cooperating slot. In an embodiment, at least part of the protrusion is flushed with the rod when connected.

In an embodiment, once the tubular rod 8 and the body portion connector 10 are engaged, as described above, a locking mechanism may be provided to hold the two elements together. Specifically, one or more bands (not shown) may be used to encircle the tubular rod 8 at the position of plug portion 20. In an embodiment, the band is a microband, such as, for example, a metal microband. The or each band may be tightenable to hold the two elements in close connection. Furthermore, when the body portion connector 10 is engaged within the tubular rod 8 a top portion of the protrusion may extend radially beyond the outermost surface of the tubular rod 8. Accordingly, a portion of the turreted profile of the protrusion 24 may extend beyond the tubular rod. Accordingly, the or each band may be located within the grooves 26 of the turreted profile. In other words, at least a portion of the protrusion 24 may extend radially beyond the band and be on a distal side of the band. Accordingly, the constricting force caused by the band in combination with at least a portion of the protrusion being a distal side of the band may act to lock the body portion connector 10 to the tubular rod 8. In other words, the locking mechanism may prevent the body portion connector 10 from sliding out of the tubular rod. In an embodiment, as seen more particularly on FIG. 3, a sleeve 29 may be positioned over the bands and the protrusion for protection, for example, from impact and/or fluid ingress. In an embodiment, the sleeve may be rubber.

In an embodiment, the connector portion 22 of the body portion connector 10 includes an electric connector having a screw thread. Stated differently, the connector portion 22 may include a screw-on electric connector. In an embodiment, the connector portion 22 includes a male connector or plug 30 having one or more electric connector pins 32. In an embodiment, the connector portion 22 may include a moveable inner-threaded ring 34 which is moveably connected to the plug 30. Stated differently, the ring 34 may move longitudinally and rotationally with respect to the plug 30, but remains attached thereto.

Returning to FIGS. 2A, 2B and 3, as mentioned above, the rotor assembly 12 may be connected to the distal end portion of the tubular rod 8. In an embodiment, the rotor assembly 12 may include a housing 50 configured in use to receive at least part of a motor (not shown). In an embodiment, the housing 50 receives the complete motor. In an embodiment, the housing and the motor may be substantially cylindrical. In an embodiment, the housing includes an aperture (not shown) in a top portion through which an axle 54 of the motor may protrude. As seen more particularly on FIGS. 2A and 2B, a rotor blade may be attached to the axle. In operation, activation of the motor may cause the axle 54 to rotate thereby rotating the rotor blade 56. Rotation of the rotor blade 56 may in turn cause the lift force which allows the rotorcraft 2 to fly.

In an embodiment, the housing 50 may further include one or more ventilation apertures 58. In operation, the ventilation apertures may promote air flow around the motor to reduce the chances that the motor will overheat. In an embodiment, the ventilation apertures include vertical slots, however, the ventilation apertures may be orientated in any direction and do not necessarily have to be vertical or in the same orientation. In an embodiment, ventilation apertures are provided on a top surface and/or a sidewall of the housing 50.

In an embodiment, the housing 50 furthers includes a bracket 52 for connecting the housing 50 to a distal end portion of the tubular rod 8. In an embodiment, the bracket 52 extends substantially along a full length of a sidewall of the housing 50. In particular, the bracket 52 may extend substantially from the bottom to the top of the housing 50. In an embodiment, the bracket includes a groove (not shown) configured in use to receive a distal end portion of the tubular rod 8. In an embodiment, the tubular rod 8 has a circular cross section having a certain diameter. Accordingly, in an embodiment, the groove has a U-shaped groove, wherein the diameter of the curved portion of the U-shape is sized and shaped to snugly receive the distal end portion of the tubular rod 8. In an embodiment, the bracket further includes one or more fastening apertures 60. In use, a faster 62 may be inserted through a fastening aperture 60 and into the distal end portion of the tubular rod 8 in order to fix the tubular rod 8 to the rotor assembly 12. In an embodiment, four fastener apertures 60 are provided, two on each side of the bracket 50. In an embodiment, a faster may be a screw, a rivet, a tack, a nail or the like. In an embodiment, an orientation of each fastener is perpendicular to an orientation of the alignment mechanism comprising protrusion 24 and slot 28.

In an embodiment, the housing 50 and the bracket 52 are configured so that at least a majority of the motor is mounted below a top surface of the tubular rod 8 when the rotor-arm 6 is attached to the body portion 4.

An embodiment of the body portion 4 will now be described in detail.

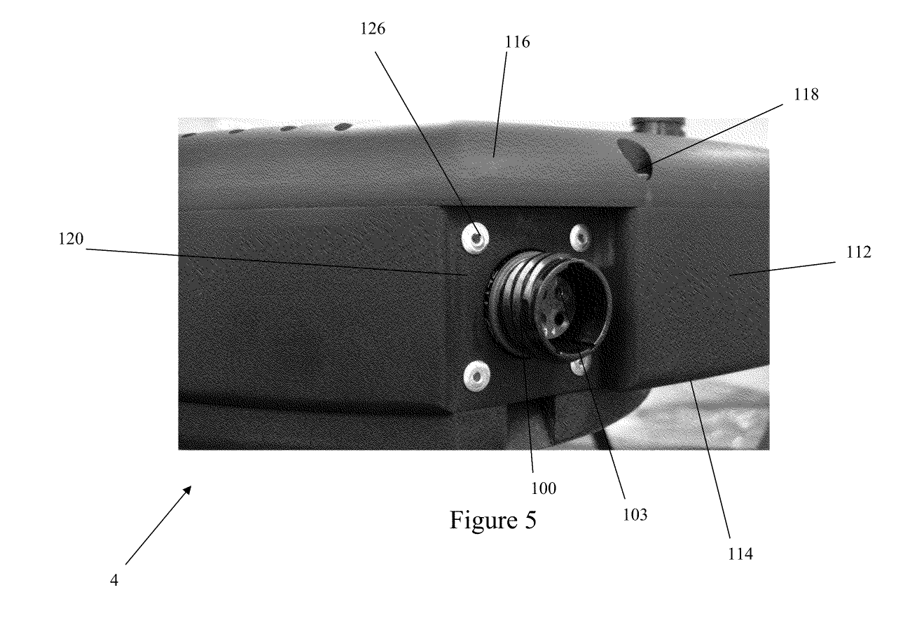

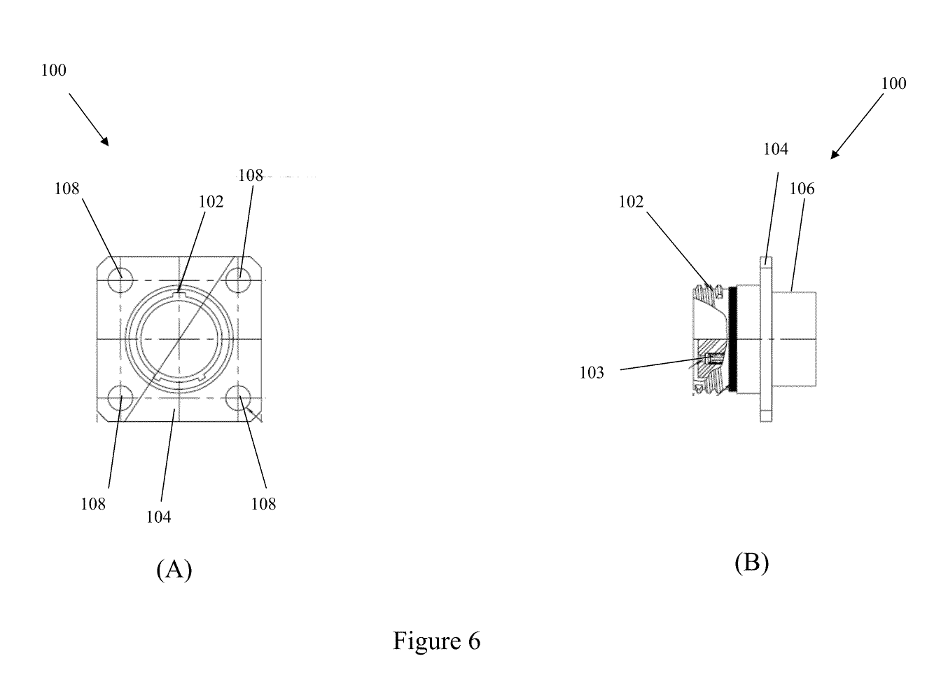

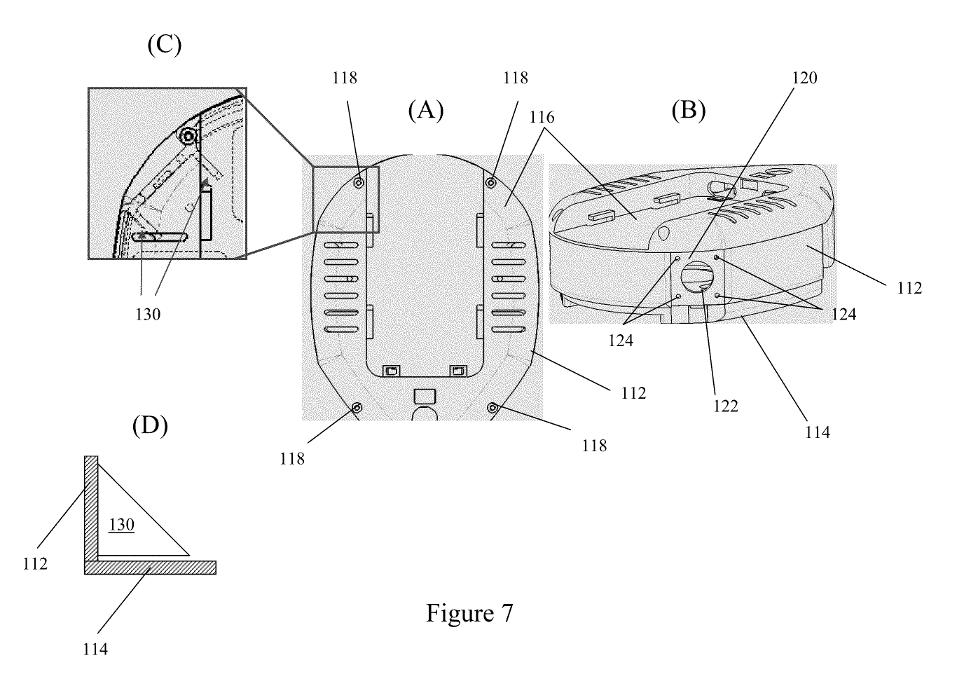

FIG. 5 illustrates a combination of the body portion 4 with a rotor-arm connector 100. FIGS. 6A and 6B illustrate the rotor-arm connector 100 without the body portion 4, whereas FIGS. 7A-D illustrate the body portion 4 without the rotor-arm connector 100.

As seen more particularly on FIGS. 6A and 6B, the rotor-arm connector 100 may include an externally-threaded female connector or socket (receptacle) 102 having one or more connection pin sockets 103. As will be readily understood from the above description, the socket 102 is configured to mate with the plug 30 in order to establish an electrical connection. This electrical connection may be used, for example, to provide electrical power and control signals to a motor in the housing 50 from a power supply (not shown) or controller (not shown) in the body portion 4. It will also be readily understood that, in use, the external thread of the socket 102 is configured to engage with the internal thread of the ring 34 in order that the rotor-arm may be screwed onto the rotor-arm connector 100, thereby attaching the rotor-arm to the body portion.

In an embodiment, the rotor-arm connector 100 further includes a flange 104 connected to a back-end portion 106 of the connector 100. The back-end portion 106 extends from the proximal end of the socket 102 and may provide structural support to the connector 100. In an embodiment, the flange 104 includes a substantially square shape, however, in other embodiments the flange 104 may have a different shape, such as, for example, triangular, circular or an irregular shape. In an embodiment, the flange 104 includes one or more fastening apertures to facilitate attachment of the rotor-arm connector 100 to the body portion 4.

As seen more particularly on FIGS. 7A-D, the body portion 4 may include a sidewall 112 and a floor 114 which together provide a tray-like compartment that is capable of housing internal elements of the rotorcraft. For example, the body portion 4 may include a power source (battery), circuitry for controlling the operation of a motor of an attached rotor-arm, and circuitry for communicating with a remote controller. Furthermore, a top-cover 116 may be provided and configured to attach to a top portion of the sidewall 112. Accordingly, the top-cover may form an enclosure with sidewall 112 and floor 114, thereby enclosing the contents of the tray-like compartment. The top-cover 116 may be provided with one or more fastener apertures 118 so that a fastener (not shown) may be inserted therethrough and into engagement with the sidewall 112. In this way, the top-cover 116 may be fixed to the body portion 4. In an embodiment, a faster may be a screw, a rivet, a tack, a nail or the like.

An advantage of the above construction may be that the contents of the body portion 4 are enclosed and therefore protected. In addition, the act of fastening the top-cover 114 to the body portion 4 may strengthen the arrangement and improve rigidity of the body portion. In an embodiment, four fastener apertures 118 together with four fasteners are provided. In an embodiment, the body portion and top-cover may have a rounded-corner square shape and a fastener aperture may be provided in each corner region.

As seen more particularly on FIGS. 5, 7B and 7C, the sidewall 112 may include a recessed portion 120. The recessed portion 120 provides a flat surface for abutting the flange 104. In an embodiment, the sidewall 112 may have a curvature and so a specific recessed portion 120 may be required. However, in some other embodiments, the sidewall 112 may be substantially flat, thus no specific recessed portion may be required. In an embodiment, the recessed portion may be generally the same size and shape as the flange, but slightly larger.

In an embodiment, the sidewall 112 also includes a connector aperture 122 for receiving the socket 102 of the connecter 100 therethrough. The connector aperture 122 may be sized and shaped to cooperate with the socket 102, such that in use the socket fits snugly through the aperture. In an embodiment, the connector 100 is inserted through the connector aperture 122 from the inside of the sidewall 112. Accordingly, the socket 102 may protrude externally from the sidewall 112, as seen more particularly on FIG. 5. In an embodiment, the connector 100 is pushed through the connector aperture 122 until the flange 104 abuts the interior surface of the sidewall 112. In an embodiment, the flange abuts a flattened portion of the sidewall 112, such as, for example, the recessed portion 120. In an embodiment, the sidewall 112 is additionally provided with one or more fastening apertures 124. In an embodiment, a fastener 126 is driven through the sidewall 112 from the exterior side to the interior side and then through one of the fastener apertures 108 of the flange. The fastener may then be secured in position. In an embodiment, a faster may be a screw, a rivet, a tack, a nail or the like. In this way, the flange may be fixed to the sidewall 112. Accordingly, the connector 100 may be fixed to the body portion 4. In an embodiment, four fastener apertures 124 are provided on the sidewall 112, and four corresponding fastener apertures 108 are provided on the flange 104. In an embodiment, the flange is substantially square shaped and the fastener apertures 108 are provided in each corner portion.

In an embodiment, the flange helps to maintain alignment of the socket 102 as well as distribute stress at the joint over a larger area.

As seen more particularly on FIG. 7C, the body portion 4 may be provided with one or more reinforcement ribs 130. Whilst two ribs 130 are shown, it is to be understood that in some other embodiments, only one of the ribs 130 may be provided. Further, it is to be understood that in some other embodiments, more than two ribs 130 may be provided.

As seen more particularly on FIG. 7D, a rib 130 may be fixed to the interior of sidewall 112. In an embodiment, the rib 130 may be formed integrally with the sidewall 112. For example, the sidewall 112 and the rib 130 may be formed from the same piece of plastic. In an embodiment, rib 130 may be substantially triangular in shape, having a first side fixed to the sidewall 112, a second side adjacent with the floor 114 and a hypotenuse spanning between the sidewall 112 and the floor 114. Accordingly, the rib 130 may be configured as a brace, and provide a bracing force between the sidewall 112 and the floor 114. Therefore, if a turning force is applied to the connector 100 by a lifting force generated by an attached rotor-arm 6, the rib 130 may reinforce the body portion 4 and connector 100 in order to strengthen the joint and avoid breakage.

In an embodiment, a rib 130 may have an alternative shape, such as, for example, a square or rectangular shape. In an embodiment, multiple ribs may be provided and one or more of the ribs may have a different shape to one or more of the other ribs.

In operation, a rotor-arm 6 may be screwed onto the body portion 4 in order to attach the rotor-arm 6 to the body portion 4. Specifically, the plug 30 may be mated with the socket 102, then the threaded ring 34 may be engaged with the thread of socket 102. Accordingly, an electrical connection between the rotor-arm 6 and the body portion 4 may be established. Furthermore, a physical connection between the rotor-arm 6 and the body portion 4 may be established. The electrical connection may be utilized to provide power and control signals between the body portion 4 and the motor controlling the rotor blades 56. Accordingly, the rotorcraft 2 may be operated to fly.

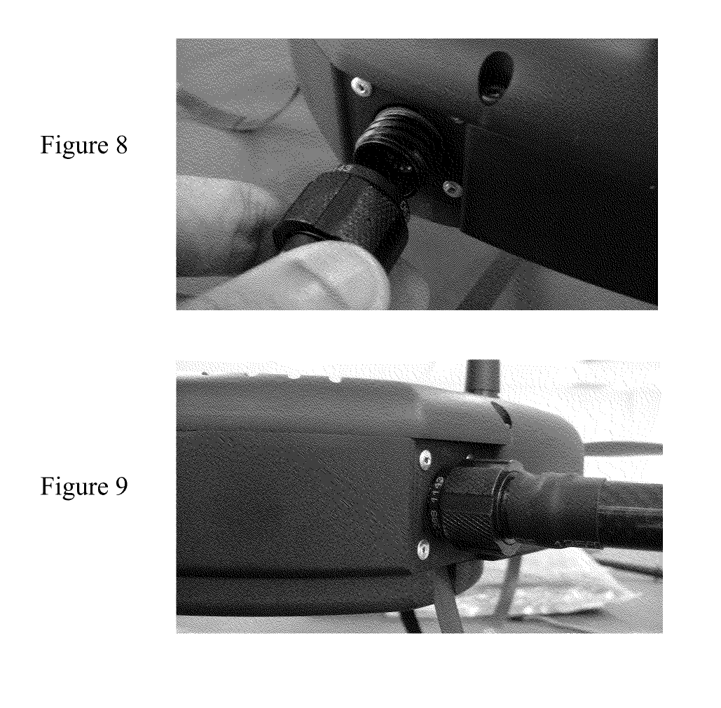

FIGS. 8 and 9 illustrate the above-described process of connecting a rotor-arm 6 to the body portion 4. FIG. 8 illustrates the step just before the plug 30 is mated with the socket 102. FIG. 9 illustrates the step just after the ring 34 has been screwed onto the socket 102.

In an embodiment, any rotor-arm may be detachably attached to any body portion connector. However, in some embodiments, a rotor-arm may only be detachably attached to one or more specific body portion connectors. For example, the connector size, screw-thread size, etc., could vary in order to limit which body connectors may be used by a particular rotor-arm connector.

Stress forces caused by lift forces generated during flight may be supported and controlled by a number of the above-described features. For example, one or more reinforcement ribs 130 may counter and support a turning force generated by the lift force. The flange 104 may spread over a larger area the turning force applied to the connector 100. The screw-on configuration of the body portion connector 10 and the rotor-arm connector 100 may provide a strong physical connection which can absorb the turning force applied to the joint by the lift force. The plug portion 20 may spread the stresses of the turning force over a larger portion of the tubular rod 8 thereby reducing the chances that the rod or joint will break. The tubular rod may be manufactured from carbon-fiber so that it is strong enough to absorb the turning force generated by the lift force. Further, the length of the tubular rod 8 may be minimized in order to minimize the turning force at the body portion/connector joint. The bracket 52 height and width may spread the stresses of the turning force over a larger portion of the tubular rod 8. The housing 50 may ensure that the source of the lift force and, therefore, the source of the turning force is below the top surface of the tubular rod 8. Accordingly, the turning force to be absorbed by the bracket 52 may be minimized and the joint strengthened.

In view of the above, the various features may act together and independently to manage the stresses caused by the lift force generated by the rotation of the rotor-blades in flight. Specifically, the various features may operate to improve strength, rigidity and durability of the various joints in the rotor-arm assembly. Furthermore, the various features may help to maintain alignment of the various joints in the rotor-arm assembly.

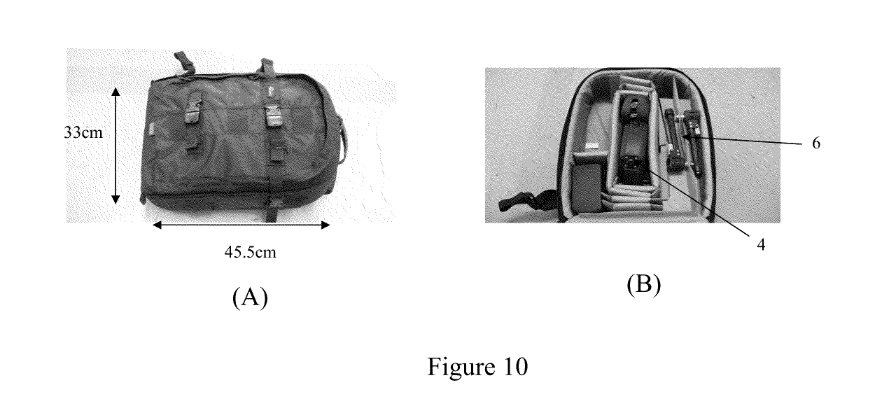

FIG. 10 illustrates the multi-rotorcraft 2 as packed. Specifically, FIG. 10 shows an exemplary bag for carrying various components of the multi-rotorcraft 2 in disassembled form. FIG. 10A shows the bag in a closed configuration, whereas FIG. 10B shows the bag in an open configuration. An advantage of the above-described embodiments is that the rotor-arms of the multi-rotorcraft are detachable. Therefore, the rotor-arms can be detached from the body portion to reduce the footprint for packing. Furthermore, detachable rotor-arms can be advantageous from a maintainability perspective. For example, the turnaround time to maintain a rotorcraft may be reduced. For example, if any motor malfunctions, a user just needs to change the rotor-arm without having to do a great deal of troubleshooting. Repair of the faulty rotor-arm can be done back in the depot. As a result, the time during which the rotorcraft has to be grounded due to any repairs can be significantly reduced, thus potentially optimizing mission time.

In an embodiment, the rotorcraft may have a footprint diameter of 480 mm and be packable into a bag having the following dimensions: 455 mm×330 mm×265 mm. In an embodiment, the bag may also contain all necessary spare parts, including, for example, rotor-arms, propellers, landing gears and batteries. In an embodiment, the bag may also contain a ground control station.

In an embodiment, the body portion connector and the rotor-arm connector are United States military standard (MIL-STD) certified.

It is to be understood that the multi-rotor-craft may include any number of rotor-arms 6, and that no matter how may rotor-arms are provided, the above mentioned features will act independently and in combination to control and absorb the stresses caused by the lift force generated by each rotor-arm. As shown in FIG. 1, in an embodiment, the multi-rotorcraft may include four rotor-arms.

Various embodiments provide a rotor-arm assembly for a multi-rotorcraft, the rotor-arm assembly comprising: a plurality of rotor-arms, each rotor-arm comprising a rotor assembly at a distal end portion and a body portion connector at a proximal end portion, the body portion connector having a screw thread; and a body portion comprising a plurality of rotor-arm connectors, each rotor-arm connector having a screw thread; wherein the screw-thread of each body portion connector is configured in use to engage with the screw-thread of one of the rotor-arm connectors to detachably attach each rotor-arm to the body portion. It is an advantage of this embodiment that a strong screw-on physical and electrical connection is provided between the rotor-arm and the body portion.

In an embodiment, a rotor-arm further includes a tubular rod. In an embodiment, the body portion connector of the rotor-arm includes a plug portion, the plug portion being adapted to fit inside a proximal end portion of the tubular rod to fix the body portion connector to the tubular rod. It is an advantage of this embodiment that stresses caused by a turning force resulting from a lift force caused by the rotor assembly may be spread over a larger area of the tubular rod.

In an embodiment, the rotor-arm further includes an alignment mechanism configured in use to align the body portion connector with respect to the tubular rod when the tubular rod and the body portion connector are fixed together. An advantage of this embodiment is that the rotor assembly may be repeatably and quickly put into the correct orientation. For example, if the rotor assembly is in the correct orientation, the lift force generated by the rotor assembly may be vertically up.

In an embodiment, the alignment mechanism includes a protrusion and a cooperating slot. Accordingly, a keyway (slot) for alignment is provided. An advantage of this embodiment is that manufacturing may be simplified.

In an embodiment, the alignment mechanism further includes a locking mechanism configured in use to lock together the tubular rod and the body portion connector. An advantage of this embodiment is that the body portion connector may be prevented from sliding out of the tubular rod. Further, slippage due to vibrations or prolonged use may also be avoided.

In an embodiment, the rotor assembly includes a housing configured in use to receive at least part of a motor, the housing having a bracket for connecting to a distal end portion of the tubular rod. An advantage of this embodiment is that the motor may be protected from impacts which could cause damage and malfunction.

In an embodiment, the housing includes at least one aperture for providing ventilation to the motor. An advantage of this embodiment is that overheating of the motor may be avoided.

In an embodiment, the bracket extends substantially along a full length of a sidewall of the housing. An advantage of this embodiment is that stresses caused by a turning force resulting from a lift force caused by the rotor assembly may be spread over a larger area of the housing.

In an embodiment, the bracket includes a groove configured in use to receive the distal end portion of the tubular rod. An advantage of this embodiment is that stresses caused by a turning force resulting from a lift force caused by the rotor assembly may be spread over a larger area of the tubular rod. Specifically, the length of the distal end portion received into the groove may be approximately the same as the length of the bracket covering the housing sidewall.

In an embodiment, the rotor assembly further includes a fastening configured in use to fix the distal end portion of the tubular rod to the groove. An advantage of this embodiment is that the tubular rod is fixed to the rotor assembly.

In an embodiment, an orientation of the fastening is perpendicular to an orientation of the alignment mechanism. An advantage of this embodiment is to absorb stresses felt by the rotor-assembly/tubular rod joint and the tubular rod/body portion connector joint, thereby making both joints stronger.

In an embodiment, the housing is configured in use to mount a majority of the motor below a top surface of the tubular rod when the rotor-arm is attached to the body portion. An advantage of this embodiment is to strengthen the rotor-assembly/tubular rod joint.

In an embodiment, one of the rotor-arm connectors of the body portion includes a flange and the body portion includes an aperture for receiving a portion of the rotor-arm connector therethrough, wherein the flange is configured in use to abut a sidewall of the body portion to hold the rotor-arm connector in position. An advantage of this embodiment is that stresses caused by a turning force resulting from a lift force caused by the rotor assembly may be spread over a larger area of the body portion and rotor-arm connector.

In an embodiment, the rotor-arm assembly further includes a fastening configured in use to fix the flange to the sidewall of the body portion. An advantage of this embodiment is that the rotor-arm connector may be securely attached to the body portion.

In an embodiment, the rotor-arm assembly further includes a reinforcement rib connected to an interior portion of the sidewall of the body portion. Optionally, the reinforcement rib is formed integrally with the sidewall of the body portion. Optionally, the reinforcement rib is configured in use to abut a floor of the body portion. Optionally, the reinforcement rib is perpendicular to the sidewall of the body portion and the floor of the body portion. Optionally, the reinforcement rib has a substantially triangular shape. An advantage of at least some of these embodiments is that stresses caused by a turning force resulting from a lift force caused by the rotor assembly may be spread over a larger area of the body portion.

In an embodiment, the rotor-arm assembly further includes a detachable top-cover, the detachable top-cover being connectable to the body portion via a fastening. An advantage of this embodiment is that the contents of the body portion may be protected. Another advantage of this embodiment is that rigidity of the body portion may be improved.

Various embodiments provide a multi-rotorcraft comprising a rotor-arm assembly of any one of the above-described embodiments.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A rotor-arm assembly for a multi-rotorcraft, the rotor-arm assembly comprising:
a plurality of rotor-arms, each rotor-arm comprising a rotor assembly at a distal end portion and a body portion connector at a proximal end portion, the body portion connector having a screw thread; and
a body portion comprising a plurality of rotor-arm connectors, each rotor-arm connector having a screw thread;
wherein the screw-thread of each body portion connector is configured in use to engage with the screw-thread of one of the rotor-arm connectors to detachably attach each rotor-arm to the body portion.

2. The rotor-arm assembly of claim 1, wherein a rotor-arm further comprises a tubular rod.

3. The rotor-arm assembly of claim 2, wherein the body portion connector of the rotor-arm comprises a plug portion, the plug portion being adapted to fit inside a proximal end portion of the tubular rod to fix the body portion connector to the tubular rod.

4. The rotor-arm assembly of claim 3, wherein the plug portion is configured in use to extend about 20 mm inside the tubular rod from the proximal end portion.

5. The rotor-arm assembly of claim 2, wherein the rotor-arm further comprises an alignment mechanism configured in use to align the body portion connector with respect to the tubular rod when the tubular rod and the body portion connector are fixed together.

6. The rotor-arm assembly of claim 5, wherein the alignment mechanism comprises a protrusion and a cooperating slot.

7. The rotor-arm assembly of claim 5, wherein the alignment mechanism further comprises a locking mechanism configured in use to lock together the tubular rod and the body portion connector.

8. The rotor-arm assembly of claim 7, wherein the alignment mechanism comprises a protrusion and a cooperating slot, wherein the tubular rod comprises the slot and the body portion connector comprises the protrusion, at least part of the protrusion being configured in use to extend radially beyond an outer surface of the tubular rod when the tubular rod and the body portion connector are fixed together, wherein the locking mechanism comprises a band configured in use to tighten around a circumference of the tubular rod at a proximal side of the at least part of the protrusion.

9. The rotor-arm assembly of claim 2, wherein the rotor assembly comprises a housing configured in use to receive at least part of a motor, the housing having a bracket for connecting to a distal end portion of the tubular rod.

10. The rotor-arm assembly of claim 9, wherein the housing comprises an aperture in a top portion, the aperture being configured in use to receive a motor axle therethough.

11. The rotor-arm assembly of claim 9, wherein the housing comprises at least one aperture for providing ventilation to the motor.

12. The rotor-arm assembly of claim 9, wherein the bracket extends substantially along a full length of a sidewall of the housing.

13. The rotor-arm assembly of claim 9, wherein the bracket comprises a groove configured in use to receive the distal end portion of the tubular rod.

14. The rotor-arm assembly of claim 13, wherein the rotor assembly further comprises a fastening configured in use to fix the distal end portion of the tubular rod to the groove.

15. The rotor-arm assembly of claim 14,
wherein the body portion connector of the rotor-arm comprises a plug portion, the plug portion being adapted to fit inside a proximal end portion of the tubular rod to fix the body portion connector to the tubular rod;
wherein the plug portion is configured in use to extend about 20 mm inside the tubular rod from the proximal end portion;
wherein the rotor-arm further comprises an alignment mechanism configured in use to align the body portion connector with respect to the tubular rod when the tubular rod and the body portion connector are fixed together;
wherein an orientation of the fastening is perpendicular to an orientation of the alignment mechanism;
wherein a rotor-arm further comprises a tubular rod.

16. The rotor-arm assembly of claim 9, wherein the housing is configured in use to mount a majority of the motor below a top surface of the tubular rod when the rotor-arm is attached to the body portion.

17. The rotor-arm assembly of claim 1, wherein one of the rotor-arm connectors of the body portion comprises a flange and the body portion comprises an aperture for receiving a portion of the rotor-arm connector therethrough, wherein the flange is configured in use to abut a sidewall of the body portion to hold the rotor-arm connector in position.

18. The rotor-arm assembly of claim 17, further comprising a fastening configured in use to fix the flange to the sidewall of the body portion.

19. The rotor-arm assembly of claim 17, further comprising a reinforcement rib connected to an interior portion of the sidewall of the body portion.

20. The rotor-arm assembly of claim 19, wherein the reinforcement rib is formed integrally with the sidewall of the body portion.

21. The rotor-arm assembly of claim 19, wherein the reinforcement rib is configured in use to abut a floor of the body portion.

22. The rotor-arm assembly of claim 21, wherein the reinforcement rib is perpendicular to the sidewall of the body portion and the floor of the body portion.

23. The rotor-arm assembly of claim 19, wherein the reinforcement rib has a substantially triangular shape.

24. The rotor-arm assembly of claim 1, further comprising a detachable top-cover, the detachable top-cover being connectable to the body portion via a fastening.

25. A multi-rotorcraft comprising a rotor-arm assembly of claim 1.
